(19) United States
(12) Patent Application Publication
(10) Pub. No.: US 2005/0177480 A1
(43) Pub. Date: Aug. 11, 2005

(54) Intelligent billing system

(75) Inventor: Su Shiong Huang, Bellevue, WA (US)

Correspondence Address: WARREN P. KUJAWA, 1770 N. GREEN VALLEY PKWY, UNIT 3833, HENDERSON, NV, 89074, US

(73) Assignee: Silicon Valley Micro C Corporation, San Jose, CA (US)

(21) Appl. No.: 10/761,901

(22) Filed: Jan. 20, 2004

(51) Int. Cl. G06F 17/60

(52) U.S. Cl. 705/34

(57) ABSTRACT

An intelligent billing statement contains conventional visible printed billing information and an electronic copy stored in an rfid chip incorporated into the billing statement sheet media. Information stored in the rfid chip can be read out via a small antenna coupled to the chip and a reader antenna coupled to a reader without opening the envelope containing the billing statement. Envelopes containing billing statements can be read and sorted by the carrier at high speed. The recipient can read several statements simultaneously with a reader having a display with an optional imminent due date indicator. The reader has an optional communication link to a personal computer used for automatic bill payments and other financial applications.

### BACKGROUND OF THE INVENTION

This invention relates to commercial billing techniques wherein a business entity or government agency prepares a bill for products, services, taxes, license fees or the like and transmits the bill to an addressee via a carrier, such as the postal system, for payment by the addressee. More particularly, this invention relates to a method and system for preparing and transmitting bills which can be automatically read by reading stations within the carrier operation for automatic routing to the addressee, and which can be automatically read by a reading station at the location of the addressee for information and automatic payment purposes, all using rfid techniques.

Automated billing systems are known which facilitate billing preparation, carrier processing of the billing statement for delivery to the addressee, and payment by the recipient of a billing statement. Such systems currently use optical technology, such as bar code printers and readers, to provide automated sorting and routing of individual envelopes. Once received by the addressee, the individual envelope must be opened and the enclosed billing statement must be inspected, either visually or with the aid of an optical scanner, to note the amount due, the due date, and the address of the billing entity to which payment should be made (the pertinent billing information). Some businesses and individuals use a computer-based calendaring and payment system which enables a user to enter the pertinent billing information into a computer, either manually or with the aid of an optical reader, for later automatic recall on or close to the due date; or for automatic payment either electronically over a communication link or by automatic check printing.

While known, optically-based automated billing systems have proven to be useful and efficient for the entity preparing the billing statements and for the carrier responsible for physical delivery of the individual billing statements, there are certain disadvantages inherent in known optical systems which cannot be readily overcome. For example, if the entity preparing the billing statements is responsible for printing the optical coding information on the outside surface of the envelope, the coding characters must be clearly printed and precisely located on a prescribed portion of the outer surface so that the coding characters will pass through reading and sorting stations in close registration with the optical reading elements. If the carrier (e.g., the Postal Service) is responsible for printing the optical coding information on the envelope, the same constraint applies. Even carefully printed coding characters can be altered or obliterated by careless handling of the envelopes, by mechanical machine malfunctions, or by exposure to water, with the result that the envelope is either routed to the wrong destination or rejected as unreadable. Another disadvantage inherent in known automated optical billing systems lies in the fact that at least the portion of the envelope bearing the coding characters must pass through the reading station in such a manner that the coding characters can be viewed by the optical code reader in an unobstructed fashion. This is typically done by feeding the envelopes in serial fashion through the reading stations. This serial progression requirement limits the speed with which envelopes can be reliably read and processed.

Individual bill payers usually do not have automated sorting machines to help process incoming bills for payment. Some business entities receive sufficient quantities of incoming mail to justify the cost of automated sorting equipment. Ultimately, however, the contents of each envelope must be examined. Thus, when an envelope reaches the ultimate recipient, the external optical coding technique affords no advantage to the person who must open the envelope, extract the contents, review the billing statement information and take further action.

### SUMMARY OF THE INVENTION

The invention comprises a method and system for preparing and transmitting bills which can be automatically read by reading stations within the carrier operation for automatic routing to the addressee, and which can be automatically read by a reading station at the location of the addressee for automatic payment, all using rfid techniques.

In the broadest aspect, the invention comprises a sheet medium, such as paper or plastic, for providing a surface on which visible billing information can be formed, as by printing. An information storage and transfer circuit including an RFID integrated circuit and an antenna is carried by the sheet medium. The information storage and transfer circuit is capable of storing an electronic copy of the visible information in read-only form, as well as other information.

A billing statement is prepared by forming the visible version of the billing information on one or both surfaces of the sheet medium, and storing an identical version of the information in the information storage and transfer circuit. After preparation of the document, the identity of the two versions may optionally be verified by reading out the electronic version stored in the information storage and transfer circuit and comparing this version with the original electronic version. After verification, the billing statement is placed in an envelope and the envelope is forwarded to the courier.

The courier operation has rfid reading stations each having an antenna coupled to a reading circuit capable of extracting only the the address information stored in the information storage and transfer circuit on the billing statement inside the envelope for routing and delivery purposes.

Once the envelope containing the intelligent billing statement reaches the final destination, the recipient places the envelope into a simple rfid reading station having an antenna coupled to a reading circuit capable of extracting all the pertinent billing information stored in the information storage and transfer circuit on the billing statement, and a display for displaying this information. The recipient is apprised of the nature of the bill, the amount due and the due date by viewing the display without the need of opening the envelope.

The recipient's reading station is optionally provided with a visible indicator, preferably an LED, which can be operated to signify that the due date for a given bill is close. Further, the recipient's reading station is optionally provided with a data transfer device, such as a hard-wired transfer unit or a limited range rf communication unit, for transferring the extracted billing information to the recipient's personal computer. Once received by the personal computer, the extracted billing information can be processed in several different ways, depending on the preferences of the user. For example, the billing information can be used to update personal financial files, such as a running household budget; can be entered into an electronic bill payment system; and can be applied to any one of a number of financial forecasting application programs.

If the method of bill payment involves sending a portion of the billing statement back to the originator—which is typical for many business and governmental agencies—the information storage and transfer circuit can be originally incorporated into this portion of the statement so that the originator can automatically process the received payment using the rfid reading technique.

The invention eliminates the need for precision printing of optically viewable coding characters on the outer surface of the billing statement envelope. Further, since the information storage and transfer circuit in an intelligent billing statement can be read from any orientation by the rfid reader, serial processing is not required which enables high speed batch processing of envelopes. Perhaps the most significant advantage of the intelligent billing statement is the convenience to the recipient-user, who need only place the envelope in a reading station receptacle to view the contents and optionally forward the information to the user's personal computer for further processing.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a plan view of a billing statement incorporating an information storage and transfer circuit according to the invention;

FIG. 2 is a schematic view illustrating the preparation of a billing statement according to the invention;

FIG. 3 is a schematic system block diagram illustrating the preparation and delivery of billing statements according to the invention;

FIG. 4 is a perspective front view of an rfid reading station for use with the billing statement of FIG. 1;

FIG. 5 is a perspective rear view of the rfid reading station of FIG. 4;

FIG. 6 is a front view of the reading station display showing typical billing information; and

FIG. 7 is a schematic diagram showing the user reading station rfid system used with the billing statement of FIG. 1.

### DETAILED DESCRIPTION OF THE PREFERRED EMBODIMENTS

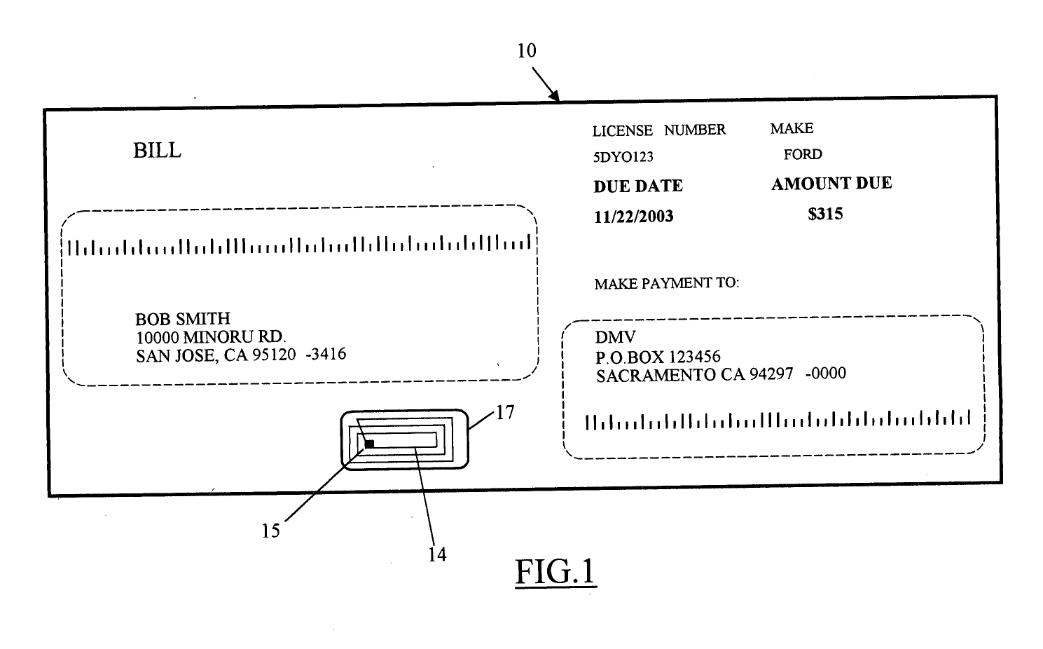

Turning now to the drawings, FIG. 1 is a plan view of the obverse side of a billing statement incorporating an information storage and transfer circuit according to the invention. As seen in this Fig., a billing statement 10 in sheet media form has visible pertinent billing information permanently formed thereon using conventional techniques, such as ink jet printing, laser printing or the equivalent. In the example of FIG. 1, the billing statement is a vehicle registration renewal notice from the Department of Motor Vehicles of the State of California, and the pertinent billing information is the registrant's name and address, license number of the vehicle, make (manufacturer) of the vehicle, due date for the registration renewal fee, amount of the renewal fee, and the address to which the fee payment should be sent. Although only the obverse side of billing statement 10 is shown in FIG. 1, visible information may also be carried by the reverse side of billing statement 10 to provide a two-sided readable document.

Incorporated into billing statement 10 are a small loop antenna 14 electrically connected to an RFID electronic chip 15. Loop antenna 14 is a multi-turn ohmic conductor formed in any one of several known ways. One such technique is silver paste printing on a polyethylene terephthalate (PET) substrate as disclosed in U.S. Pat. No. 6,373,708 B1 issued Apr. 16, 2002, the disclosure of which is hereby incorporated by reference. Another technique is copper deposition on a substrate as practiced by RCD Technology Corporation of Bethlehem, Pa. The size of the coil (coil diameter and thickness) and the number of turns will be determined by the requirements of a particular application. The function of loop antenna 14 is to provide electromagnetic transfer of information between RFID chip 15 and outside devices, such as a host CPU, a Postal Service routing reader, and a user reading station, as well as to enable inductive transfer of electrical power from an outside device to RFID chip 15 to electrically power the active circuit elements within RFID chip 15.

RFID chip 15 may be a commercially available integrated circuit device (such as a “mifare” 13.56 mHz rfid chip with 4 kb memory available from Philips Semiconductor), or a custom-designed integrated circuit device having the standard internal functional components commonly found in an RFID (radio frequency identification) integrated circuit. Such standard components include an RF and analog section, a CPU, a ROM and an EEPROM (see 1999 IEEE International Solid-State Circuits Conference publication 0-7803-5129-0/99, FIG. 9.1.1: RFID transponder IC block diagram). RFID chip 15 receives power via loop antenna 14 when interrogated by an outside device, and communicates with the outside device using standard protocols, such as the ISO 14443 protocol or the IS015693 protocol. The size of RFID chip 15 is on the order of 1.4×1.3 mm, with a thickness of about 0.13 mm. This compares favorably to the average thickness of 0.1 mm for paper used for billing statements. As will be described more fully below, when a billing statement 10 is being originally prepared, the information to be included in the billing statement is written into the ROM (read-only memory) incorporated into the RFID chip 15. Once this information is written once into the ROM, it cannot be written over or otherwise altered by any interrogation device. Stated differently, once the billing statement has been prepared, RFID chip 15 can be interrogated by an outside device and can only supply the billing statement information to the outside device—i.e, it cannot alter the billing statement information stored in the ROM.

Loop antenna 14 and RFID chip 15 are preferably both incorporated into an ID tag 17, such as that shown and described in U.S. Pat. No. 6,154,137 issued Nov. 28, 2000, the disclosure of which is hereby incorporated by reference. Generally, an ID tag has the antenna and the RFID chip mounted on or encapsulated in a thin substrate, such as the PET substrate noted above. The ID tag 17 is incorporated into the sheet media, which may be paper, plastic material such as Mylar sheet media, or any other known sheet media material used in the preparation of billing statements. Incorporation of the ID tag 17 into the sheet media may be done by adhesion to one of the sheet surfaces, bonding within the sheet media material, or by using any other known technique for firmly embedding the thin plastic ID tag into a sheet media material.

The physical location of ID tag 17 on billing statement 10 is not critical since the antenna of the various reading stations described are large enough in area to span the length and width of the sheet media used for the billing statement. The following considerations should be kept in mind when choosing the location of the ID tag 17. Firstly, if the billing statement 10 is to be placed in an envelope having a window for revealing the recipient's address, the placement of ID tag 17 should not obscure this address. Similarly, if a return envelope is provided with a window for revealing the return address, the placement of ID tag 17 should not obscure this address. If the billing statement 10 has a return portion (as is typical) which is intended to be detached from the billing statement 10 and returned with the payment, ID tag 17 may preferably be located in this return portion, since the payment can be partially processed in an automatic manner by reading out the customer information stored in rfid chip 15.

Once the sheet media has been prepared by incorporating the ID tag 17, the sheet is ready for preparation of the billing statement 10.

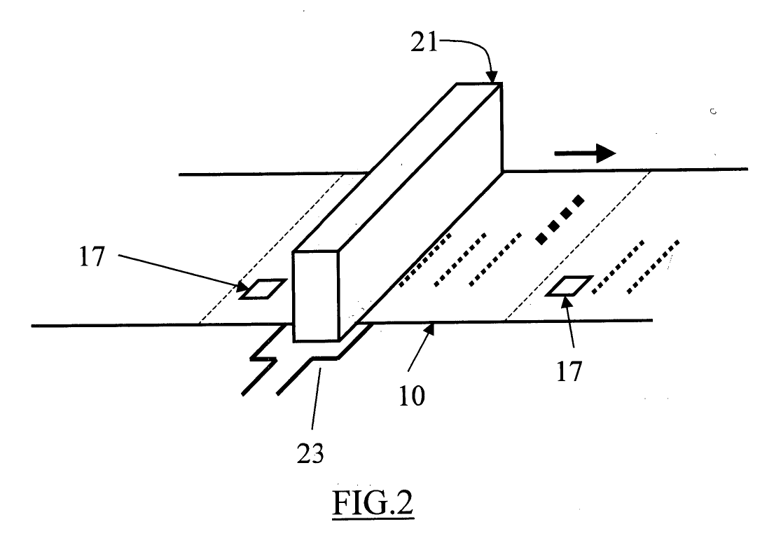

FIG. 2 schematically illustrates the manner of preparation of an intelligent billing statement 10 according to the invention. The information (which can be alpha-numeric text only, or text plus graphics) is composed using a host device, such as a PC, a word processor or any other known device for composing billing statements. Once the information is composed, it is printed onto one or both sides of the sheet media by a print mechanism 21 by feeding blank billing statement forms past the location of print mechanism 21 using a conventional feed mechanism (such as feed rollers). The same information is also electromagnetically transferred to the RFID chip 15 in rfid tag 17 and is written into the ROM portion of the RFID chip 15 using a write antenna 23 coupled to the host device. The printing step and the electromagnetic transfer step may both be conducted simulltaneously or may be performed sequentially. When both the printing and writing steps are completed, the billing statement 10 is finished, and may be placed in an envelope and forwarded to the courier for sorting and routing.

If desired, the prepared billing statement 10 may be verified in the following manner before releasing the billing statement for delivery to the intended recipient. Verification can be done by reading out the information stored in the ROM portion of the RFID chip 15 and comparing the electronic version of the information with the original electronic version in the host. This can be done most conveniently at a reading station positioned down stream of print mechanism 21. The downstream reading station extracts the stored information in rfid chip 15 using an antenna and the proper interrogation protocol, and compares this information with the original electronic version stored in the host. If the information is not a perfect match, the defective billing statement is removed from the transport path, and further appropriate steps are taken to correct the problem.

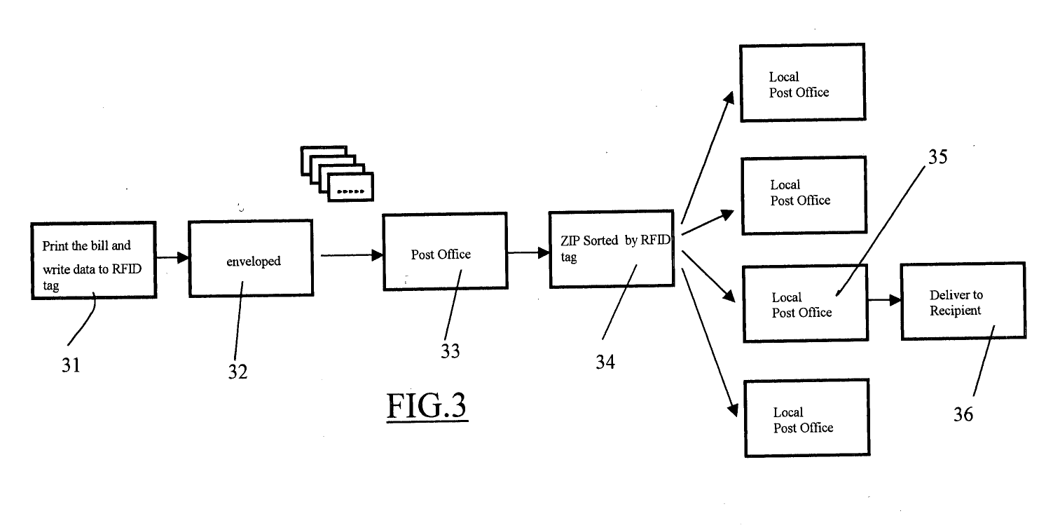

FIG. 3 is a schematic block diagram illustrating the process from preparation of the intelligent billing statement through delivery to the intended recipient. In step 31, each intelligent billing statement 10 is prepared in the manner described above. Each prepared statement 10 is inserted into an envelope in step 32 and many such envelopes are presented to the carrier, in this case the Postal Service, in step 33. In step 34, the envelopes are automatically sorted by reading and sorting stations within the Postal Service. Each such reading and sorting station is equipped with an rfid reader having an antenna for transferring electrical power into the individual rfid chips 15 to activate the circuitry therein and for reading out only the address information stored in each rfid chip 15. This limited read out function can be achieved in a number of known ways, such as by preceding address information with header data identifying the data immediately following as address information and limiting access of the Postal Service rfid readers to data having headers of this type. The address information read out from the rfid chips 15 is used to control conventional sorting equipment, which directs each envelope to the proper destination receptacle within the Postal Service. As illustrated, this can conveniently be done using the ZIP code portion of the address information. It is significant to note that the physical orientation of the rfid chips 15 is not critical for the reading process: the information can be extracted from the rfid chips 15 as they pass through the reading station in virtually any attitude. Consequently, the envelopes can be sorted much more rapidly than optically encoded envelopes. Thus, the through-put of the envelopes containing the rfid provisioned billing statements 10 can be substantially greater than known optical sorting systems. Once the envelopes have been sorted, they are delivered to the correct Local Post Office in step 35 for further sorting (if necessary), and delivery to the recipient in step 36.

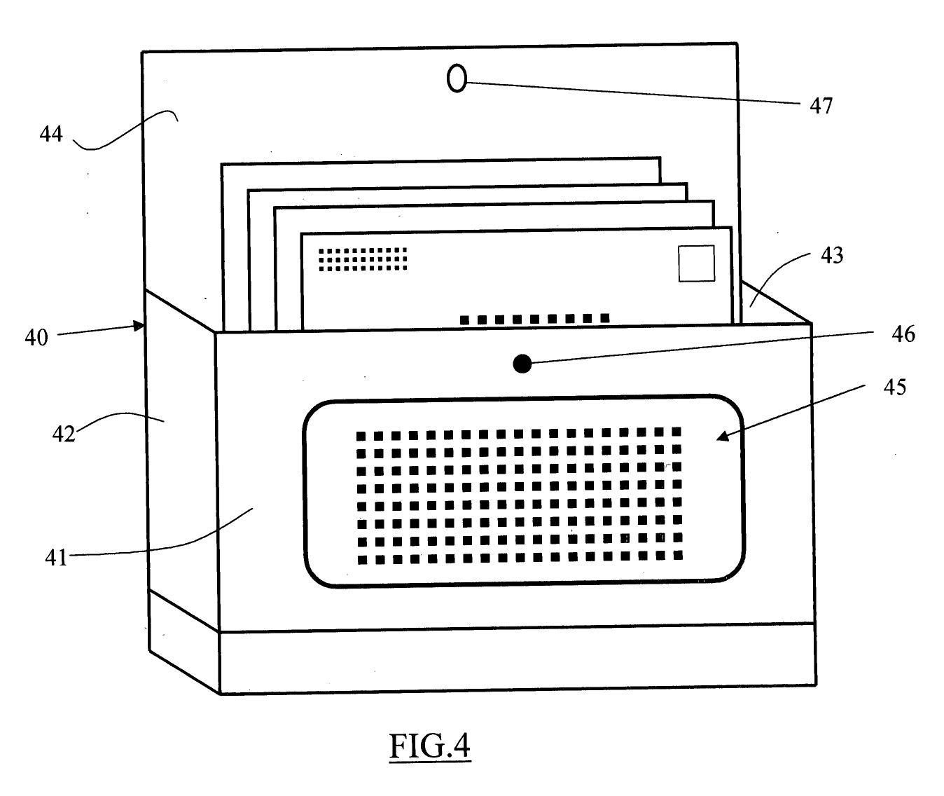

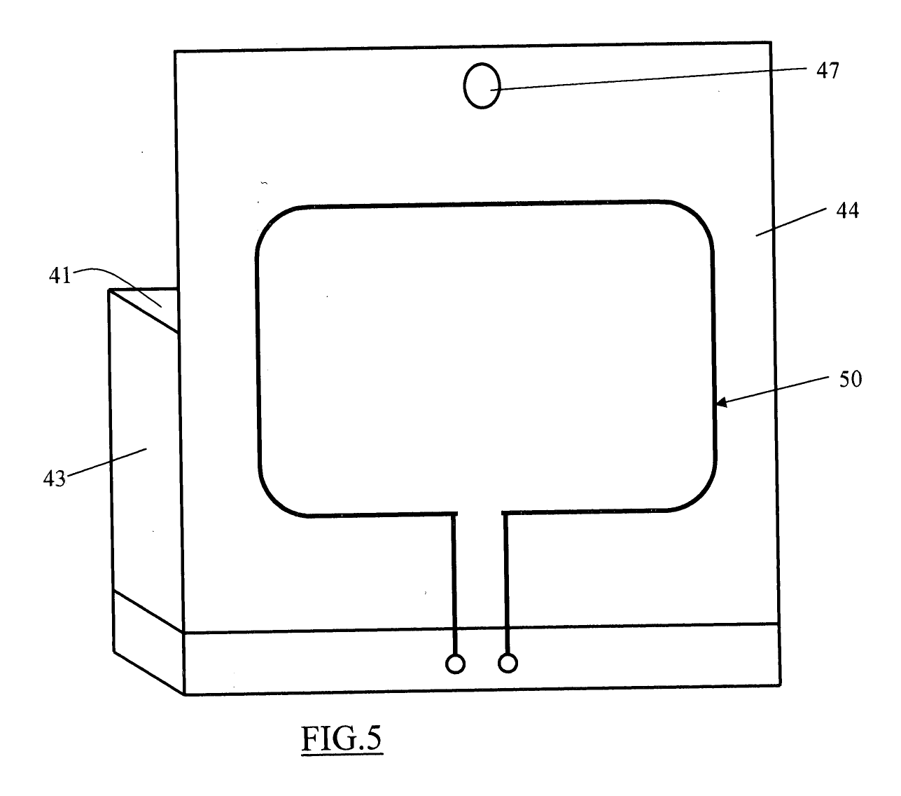

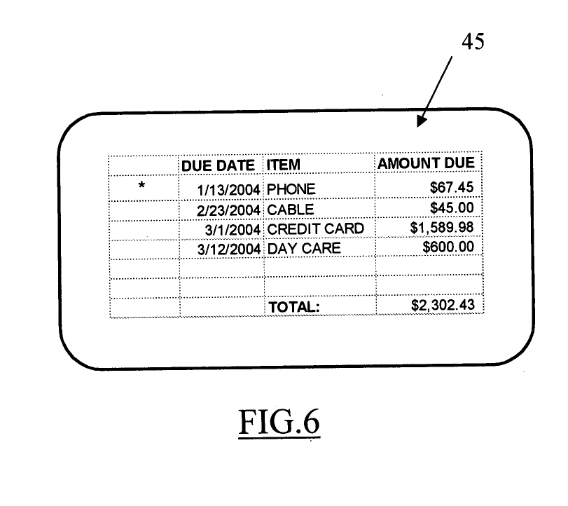

Once delivered, each billing statement 10 can be examined by the recipient without opening the envelope containing the statement 10. With reference to FIGS. 4 and 5, the recipient has a reading station 40 with a front wall 41, two side walls 42, 43, and a rear wall 44 forming an open receptacle into which the envelopes can be deposited. A matrix display 45 is located on front wall 41, along with an optional indicator 46. Matrix display 45 may be an LED display, an LCD display, or any other display device capable of displaying alpha-numeric characters in the manner shown in FIG. 6. Rear wall 44 preferably extends upwardly of the top edges of walls 41-43, and has an aperture 47 for mounting station 40 on a wall surface by means of a conventional hanger element, such as a nail, a hook, a picture hanger, or the equivalent.

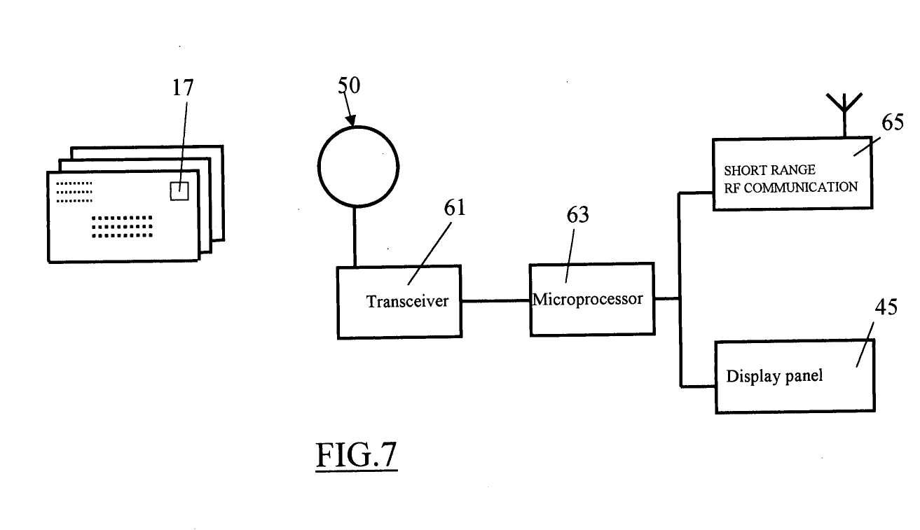

As shown in FIG. 5, a read antenna 50 is mounted on or within rear wall 44. Read antenna 50 has sufficient area to efficiently interact with the antennae 14 carried by the billing statements 10. With reference to FIG. 7, which is a block diagram of the major components of the recipient's reading station, antenna 50 is coupled to a transceiver 61, which is coupled to a microprocessor 63. Microprocessor 63 controls the operation of transceiver 61, display 45, and an optional link to the recipient's personal computer (not shown). Transceiver provides the power and data interface between microprocessor 63 and antenna 50: when directed by microprocessor 63, transceiver 61 provides electrical energy to antenna 50, which converts this energy to electromagnetic energy emanating from antenna 50. This energy is intercepted by the chip antennae 14 to power up the rfid chips 15. Transceiver 61, when directed by microprocessor 63, interrogates the rfid chips 15 via antenna 50 and antennae 14 and extracts the billing statement information stored in each chip 15. This information is coupled to microprocessor 63, which processes the information into a form suitable to drive display 45 and provide the visible display information shown in FIG. 6. Thus, the recipient can view the information content of each billing statement placed into reading station 30: if only one such billing statement is placed in reading station 40, only one item will be displayed by display 45; if two or more billing statements are placed in reading station 40, a like number of items will be displayed by display 45.

When optional indicator 46 is included in the reading station 40, microprocessor 63 is programmed to recognize the due dates in each billing statement 10, and operate indicator 46 in a steady or flashing mode whenever the due date of one or more bills is close to the current date. The minimum date separation between the current date and the due date (i.e., 2 days, 5 days, etc.) is a matter of choice for the designer.

Similarly, microprocessor 63 can be programmed to highlight one or more displayed items on display 45 for which the due date is imminent, and indicator 46 may be dispensed with. The highlighting may be done by operating display 45 in a flashing mode for the closely-due item(s), or by operating the display 45 in a higher powered mode for such items. If display 45 is a multi-colored display, imminently due bills can be highlighted by using a different color (e.g. red) for such bills and another color (such as green) for other bills.

For those recipients with computer-based programs for bill payments, personal financial data processing, financial forecasting, and the like, the reading station may be provided with a data link to the recipient's personal computer. One such link is shown in FIG. 7. As seen in this Fig., reading station 40 includes a wireless link 65 capable of transmitting data received from microprocessor 63 to a personal computer (not shown). Link 65 is preferably a short range r.f. communication device, such as a commercially available unit employing Bluetooth wireless r.f. technology.

As will now be apparent, the invention enables the preparation of billing statements which can be easily processed for sorting by a carrier at relatively high speed with great accuracy. In addition, billing statements incorporating the invention can be conveniently inspected by the recipient without the need for opening the envelopes in which they are contained. Moreover, several billing statements can be read at the same time and their information displayed for inspection by the recipient in block form. When equipped with the imminent alert function, the recipient can be warned of a close bill payment date and thus be prompted to take immediate action, again without ever opening the envelope. Lastly, the invention can be a valuable addition to a computer-based automatic bill payment system, and various computer-based financial programs. All of these advantages are afforded by the invention at relatively low cost to the recipient-user, and the billing statement reading process is virtually automatic and thus easy to use.

While the invention has been described with reference to a particular implementation, various modifications, alternate constructions and equivalents may be employed without departing from the spirit of the invention. For example, while reading station 40 is illustrated as a box-like structure, other shapes and forms can be used. Further, while link 65 has been disclosed as a wireless device, a hard-wired implementation using the available input ports of a desk top or lap top computer may be made, as desired. Therefore, the above should not be construed as limiting the invention, which is defined by the appended claims.

1. An intelligent billing statement comprising:
a sheet medium for providing a surface on which billing information can be formed in a visible manner; and
an information storage and transfer circuit carried by said sheet medium for storing an electronic copy of said billing information in a read-only manner so that said billing information can be extracted for courier routing and payment purposes.

2. The invention of claim 1 wherein said information storage and transfer circuit includes an RFID integrated circuit and an antenna.

3. The invention of claim 1 wherein said electronic copy of said billing information includes address data; and wherein said information storage and transfer circuit includes means for limiting access of said billing information to said address data for courier routing purposes.

4. The invention of claim 1 wherein said intelligent billing statement includes a separable return portion; and wherein said information storage and transfer circuit is physically located within said return portion.

5. A method of preparing an intelligent billing statement, said method comprising the steps of:
(a) providing a sheet medium having a surface on which billing statement information can be formed and an information storage and transfer circuit in which billing statement information can be stored;
(b) forming billing statement information on the surface of the sheet medium in visible form; and
(c) storing an identical version of the billing statement information formed in step (b) in the information storage and transfer circuit in a read-only manner so that the prepared billing statement contains a visible version of the information and an electronic version of the information which cannot be altered but can be extracted for courier routing and payment purposes.

6. The method of claim 5 wherein said step (c) of storing includes the step of inductively transferring the information into the information storage and transfer circuit through an antenna included therein.

7. The method of claim 5 wherein said billing statement information includes address data; and wherein said step (c) of storing includes the step of storing address data identifiers for enabling access of said billing information to be limited to said address data for courier routing purposes

8. The method of claim 5 further including the step of verifying the billing statement after initial preparation by reading out the information stored in the information storage and transfer circuit to enable a comparison between the stored version and the original version.

9. The method of claim 5 further including the steps of placing a prepared billing statement in an envelope, transferring the envelope to a courier, sorting the envelope by reading out the address data from the information storage and transfer circuit and directing the envelope to a courier destination in accordance with the address data, and delivering the envelope to the address specified by the address data.

10. The method of claim 9 further including the steps of placing the envelope in a reader, reading out the billing statement information, and displaying the billing statement information on a display device.

11. The method of claim 10 wherein the billing statement information includes a due date; and wherein said method further includes the steps of comparing the billing statement information due date with the current date, and displaying an alert condition when the difference between the due date and the current date is less than a threshold amount.

12. The method of claim 11 wherein the step of displaying an alert condition is performed by operating an alert indicator.

13. The method of claim 10 further including the step of transferring the billing statement information to a computer for further processing.

14. The method of claim 13 wherein said step of transferring is performed using wireless transmission of the billing statement information.

15. A reading station for enabling extraction of billing statement information from an information storage and transfer circuit carried by a billing statement contained in an envelope, said information storage and transfer circuit having an electronic copy of billing information printed on said billing statement stored therein in a read-only manner; said reading station comprising:
a housing having front, side and rear walls forming a receptacle for receiving said envelope
an antenna carried by one of said walls;
a display carried by one of said walls; and
an rfid reading system comprising a transceiver coupled to said antenna and a processor coupled to said transceiver and said display for inductively transferring energy to said information storage and transfer circuit, for reading said billing statement information therefrom, and for displaying said billing statement information on said display.

16. The invention of claim 15 wherein said antenna is carried by said rear wall.

17. The invention of claim 15 wherein said display is carried by said front wall.

18. The invention of claim 15 wherein said display comprises a matrix display capable of displaying several lines of information.

19. The invention of claim 15 wherein said billing statement information includes a due date; and wherein said rfid reading system includes circuitry for comparing said due date with the current date and providing a visible alert when the difference between the due date and the current date is less than a threshold amount.

20. The invention of claim 15 further including a communication link coupled to said processor for enabling transfer of billing statement information read out from said information storage and transfer circuit by said rfid reading system to a computer.
